(19) United States
(12) Patent Application Publication
(10) Pub. No.: US 2025/0122755 A1
(43) Pub. Date: Apr. 17, 2025

(54) Adaptive Tool For Winding Torsion Springs And Balancing Garage Door Suspension Systems And Associated Method Of Use Of The Adaptive Tool In Balancing Garage Door Suspension Systems

(71) Applicant: David Detman, Fenton, MI (US)

(72) Inventor: David Detman, Fenton, MI (US)

(21) Appl. No.: 18/913,263

(22) Filed: Oct. 11, 2024

Related U.S. Application Data
(60) Provisional application No. 63/543,946, filed on Oct. 13, 2023.

(51) Int. Cl. E05D 13/00; B25F 3/00; E05D 15/38

(52) U.S. Cl. CPC E05D 13/1215; B25F 3/00; E05D 15/38; E05Y 2900/106

(57) ABSTRACT

An adaptive tool for winding a torsion spring of a garage door suspension system is provided. The adaptive tool includes a hollow rod configured to interact with a power tool, the hollow rod defining a cavity configured to receive a component of the garage door suspension system and an aperture configured to receive a fastener for coupling the hollow rod to the component of the garage door suspension system and including an exterior surface, the exterior surface having a plurality of faces configured to be gripped by the power tool.

### FIELD OF THE DISCLOSURE

This disclosure generally relates to adaptive devices or tools for applying rotational force to springs (i.e., for winding a spring). More specifically, this disclosure relates to an adaptive tool for winding torsion springs and balancing a garage door suspension system and an associated method of use of the adaptive tool in balancing a garage door suspension system.

### BACKGROUND

Garage doors typically rely on a suspension system with one or more torsion springs, which allow for manual opening and/or opening by an electric door operator. The torsion springs take a portion of the weight of the garage door, and wind or unwind as the door opens and closes. In order to set up a garage door suspension system, the one or more torsion springs must be wound to an appropriate degree, depending on the size of the spring and the weight of the door. Heavier doors may require larger and heavier springs, or a multitude of springs.

Conventionally, the torsion springs are wound using a manual process. The torsion spring is mounted over a spring bar, and one end of the torsion spring is secured to a central mounting block. The second end of the torsion spring has a winding cone, which may be used in conjunction with winding bars to rotate the second end of the torsion spring relative to the first, thereby adding tension to the torsion spring. However, this existing method is prone to error and highly labor-intensive. In addition, it is very difficult to wind more than one torsion spring at a time, and the majority of conventional garage doors require two torsion springs. Another limitation for existing methods is that they require a multitude of tools, installation of additional parts, or are unable to wind multiple torsion springs simultaneously.

Accordingly, there remains a need in the art to address one or more of the challenges outlined above.

### SUMMARY OF THE DISCLOSURE

The subject disclosure provides an adaptive tool for winding a torsion spring of a garage door suspension system. The adaptive tool includes a hollow rod, which is configured to interact with a power tool. The hollow rod defines a cavity that may receive a spring bar of the garage door suspension system. The hollow rod also defines an aperture configured to receive a fastener for coupling the hollow rod to the spring bar. The hollow rod further includes an exterior surface having a plurality of faces configured to be gripped by the power tool.

The subject disclosure also provides a method of winding a torsion spring of a garage door suspension system with an adaptive tool having a hollow rod, the hollow rod defining a cavity configured to receive a component of the garage door suspension system and an aperture configured to receive a fastener. The method includes steps of sliding the hollow rod over the component of the garage door suspension system such that the component is contained within the cavity, securing the hollow rod to the component of the garage door suspension system by inserting a fastener through the aperture, gripping the hollow rod with a power tool, and actuating the power tool to rotate the hollow rod and the component of the garage door suspension system to add tension to the torsion spring.

The subject disclosure further provides a method of balancing a garage door suspension system with an adaptive tool having a hollow rod, the hollow rod defining a cavity configured to receive a component of the garage door suspension system and an aperture configured to receive a fastener. The method includes steps of displacing a second end of the torsion spring longitudinally along the spring bar based on a size of the torsion spring, securing a position of the torsion spring along the component by coupling the second end of the torsion spring to the spring bar, sliding the hollow rod over the spring bar such that the spring bar is contained within the cavity, securing the hollow rod to the cable rod by inserting a fastener through the aperture, and gripping the hollow rod with a power tool. The method further includes actuating the power tool to rotate the hollow rod and the spring bar, removing the first cable from the first cable drum and the second cable from the second cable drum, actuating the power tool to rotate the hollow rod and the component a number of rotations to add tension to the torsion spring, the number of rotations based on the size of the torsion spring, attaching the first cable to the first cable drum and the second cable to the second cable drum, actuating the power tool to rotate the hollow rod and the component to increase the tension on the first cable and the second cable and removing the fastener from the aperture, then removing the hollow rod from the spring bar such that the spring bar is no longer contained within the cavity.

### BRIEF DESCRIPTION OF THE FIGURES

Other advantages of the present disclosure will be readily appreciated, as the same becomes better understood by reference to the following detailed description when considered in connection with the accompanying drawings.

FIG. 1 is a perspective view of a garage door suspension system, according to one implementation.

FIGS. 2 and 3 are perspective views of an adaptive tool for winding a torsion spring, according to one implementation.

FIG. 4 is a front view of the adaptive tool of FIG. 2, according to one implementation.

FIG. 5 is a side view of the adaptive tool of FIG. 2, according to one implementation.

FIG. 6 is a perspective view of the adaptive tool of FIG. 2 mounted on a spring rod of the garage door suspension system of FIG. 1, according to one implementation.

FIG. 7 is a side view of a power tool gripping the adaptive tool of FIG. 2 mounted on the spring rod of FIG. 6, according to one implementation.

FIG. 8 is a front view of the power tool of FIG. 7 gripping the adaptive tool of FIG. 2 mounted on the spring rod of FIG. 6, according to one implementation.

FIG. 9 is a front view of the garage door suspension system of FIG. 1 including the adaptive tool of FIG. 2 and the power tool of FIG. 7, according to one implementation.

FIG. 10 is a perspective view of a pre-stretching device, according to one implementation.

FIG. 11 is a front view of the pre-stretching device of FIG. 10 in use in the garage door suspension system of FIG. 1, according to one implementation.

FIG. 12 is a perspective view of two cable lock devices, according to one implementation.

FIG. 13 is a perspective view of the cable lock device of FIG. 12 in use in the garage door suspension system of FIG. 1, according to one implementation.

FIG. 14 is a perspective view of a spring locking device in an open configuration, according to one implementation.

FIG. 15 is a perspective view of the spring locking device of FIG. 14 in a closed configuration, according to one implementation.

FIG. 16 is a perspective view of the spring locking device of FIG. 14 in use in the garage door suspension system of FIG. 1, according to one implementation.

FIG. 17 depicts a method of winding a torsion spring of the garage door suspension system of FIG. 1, according to one implementation.

FIG. 18 depicts a method of balancing a garage door of the garage door suspension system of FIG. 1, according to one implementation.

### DETAILED DESCRIPTION OF THE DISCLOSURE

Referring to the Figures, wherein like numerals indicate like or corresponding components throughout the several views, an adaptive tool 130 for winding torsion springs 104 used on a garage door 114 as part of a garage door suspension system 100 is shown. The adaptive tool 130 is configured for use with a power tool 150.

### I. System Overview

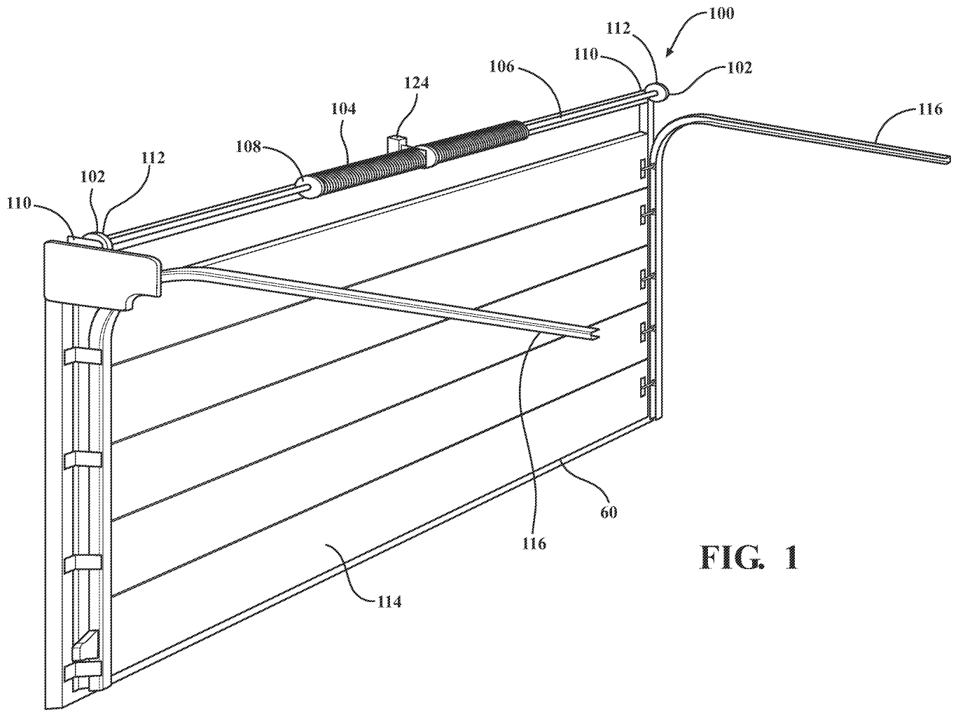

Referring to FIG. 1, the garage door suspension system 100 is shown. The garage door suspension system 100 includes at least one torsion spring 104, a cable drum 102, a spring bar 106, and a garage door 114. In the embodiment shown herein, the garage door suspension system 100 includes two torsion springs 104. The spring bar 106 may be inserted through each torsion spring 104 and mounted to a wall with a center mounting plate 124. Each torsion spring 104 may include a winding cone 108. The winding cone 108 may be non-rotatably attached to the torsion spring 104, and releasably attached to the spring bar 106 by set screws (not shown). The cable drums 102 may also be mounted to opposite ends of the spring bar 106. The cable drums 102 include cables 112 seated within the cable drums 102. The garage door suspension system 100 also includes a plurality of brackets 110 that may mount the spring bar 106 to a wall and hold the cable drums 102. The garage door 114 may be configured to be seated in a track 116 on both sides of the garage door 114. The tracks 116 may be mounted to a wall and allow the garage door 114 to move along them. The cables 112 connect the garage door 114 to the cable drums 102 and allow for the garage door 114 to travel along the tracks 116.

The garage door 114 opens as it travels upward along the tracks 116 when force is provided to the cables 112 to retract them. In garage door suspension systems, this force is initially provided by an electric door operator or manual lifting of the garage door 114 by a user. By itself, however, this force may not be enough to overcome the weight of the garage door 114 (i.e., the electric door operator may not be able to provide enough rotational force to lift the cables 112, or the user may not be strong enough to apply enough force lift the garage door 114 easily), and an additional force may be required. In the embodiments herein, this additional force is provided by the torsional force of the torsion springs 104, as the torsion springs 104 unwind. The upward motion of the garage door 114 motivated by the force applied to the cables 112 by the motor or user, which activates the torsional force of the torsion springs 104, which unwind and rotate the spring bar 106. The rotation of the spring bar 106 rotates the cable drums 102, and the cables 112 retract to wrap around the cable drums 102. In turn, this lifts the garage door 114 until the track 116 bends, where it becomes easier for the electric door operator and/or the user to open the garage door 114 the rest of the way. Similarly, the closing of the garage door 114 is accomplished when an outer force provided by the electric door operator or user begins to move the garage door 114 in the opposite direction, and as the garage door 114 moves past the bend in the tracks 116, the torsion springs 104 connected to the spring bar 106 begin to wind, allowing the cables 112 to oppose the force of gravity on the garage door 114 and lower the garage door 114 at a safe velocity. The degree to which the garage door suspension system 100 is balanced is determined by the torsional force provided by the torsion springs 104 when wound. If the torsion springs 104 are wound too tightly, the garage door 114 will not close and will open too easily. If the torsion springs 104 are not wound enough, the garage door 114 will be too heavy to comfortably open with an electric door operator or by the user and will close too easily.

To provide the right amount of balancing for opening and closing the garage door 114 easily, the torsion springs 104 are wound prior to initial use of the garage door 114. As known in the industry and appreciated by someone skilled in the art, known spring winding methods require manual labor, extensive time, and physical danger. The adaptive tool 130 provides a safer and more efficient method of winding torsion springs 104 prior to use of the garage door 114.

### II. Adaptive Tool

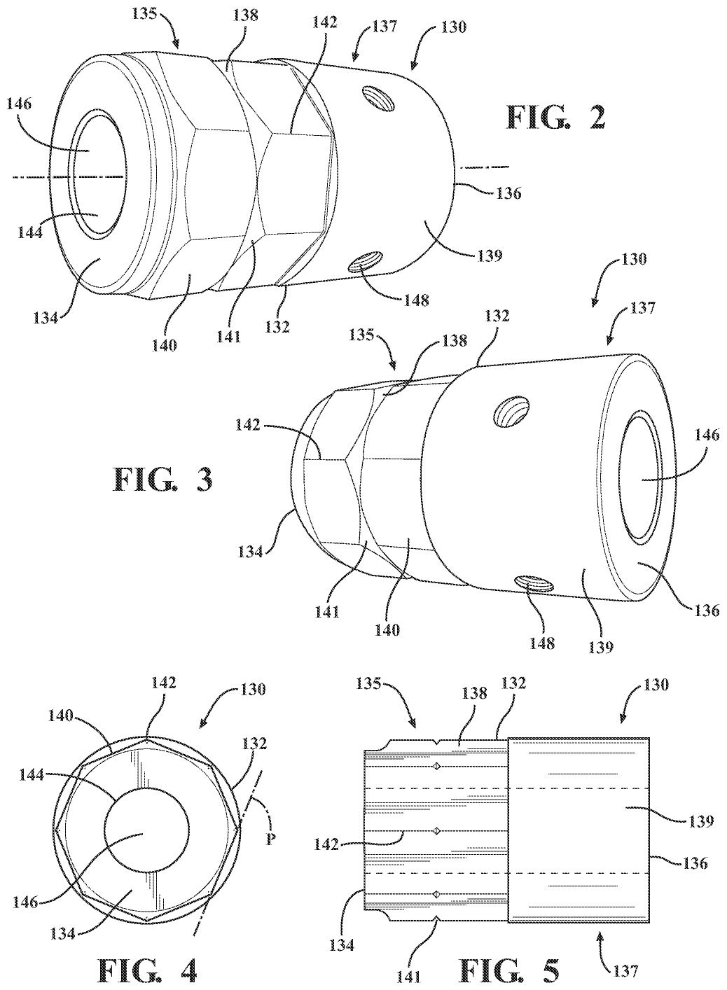

As shown in FIGS. 2-5, the adaptive tool 130 is preferably in the form of a hollow rod 132 extending in length between a first end 134 and a second end 136. The hollow rod 132 may include a first section 135 and a second section 137, respectively defined by the first end 134 and the second end 136. The first section 135 may include an outer surface 138 defining a plurality of faces 140, each pair of faces 140 separated by an edge 142. In the illustrated embodiment, there are two sets of faces 140 separated by a gap 141. Each set of faces 140 may include eight faces 140, where each face 140 is flat and defines a plane P, with the planes P of two faces 140 sharing an edge 142 being transverse to each other. Referring to FIG. 5, the first section 135 and the second section 137 are substantially the same size, the hollow rod 132 being divided in half between the first section 135 and the second section 137. In other embodiments, the first section 135 may be a different size than the second section 137, and the sets of faces 140 may extend beyond the first section 135. Further, the first section 135 may include just one set of faces 140 which extend between the first end 134 and the second section 137. In other embodiments, it is contemplated that the faces 140 are defined by the first end 134 and the second end 136. As shown in FIG. 4, the faces 140 may form a polygonal outer shape which includes three or more faces 140 with each adjacent pair of faces 140 separated by a respective edge 142. In the embodiment shown, the polygonal outer shape of each set of faces 140 defines a regular polygonal shape, with each face 140 being equal in width and the angle between the planes P of faces 140 being equal. In the embodiment illustrated in FIGS. 2 and 3, the regular polygonal shape of the sets of faces 140 has a regular octagonal shape.

Referring to FIG. 3, the second section 137 of the hollow rod 132 is shown. The second section 137 includes a cylindrical surface 139. The cylindrical surface 139 extends between the first section 135 and the second end 136. In other embodiments, the second section 137 may include an external surface having a different shape, such as a regular rectangular shape.

The hollow rod 132 also includes an inner surface 144 extending in length between the first end 134 and the second end 136. The inner surface 144 defines a cavity 146 extending in length between the first end 134 and the second end 136, and thus the cavity 146 is open at each of the first end 134 and the second end 136. In certain embodiments, the inner surface 144 is cylindrical, and thus the cavity 146 is further defined as a cylindrical cavity 146 extending in length between the first end 134 and second end 136 within the inner surface 144 with a cylindrical opening at each of the first end 134 and second end 136.

In certain embodiments, the hollow rod 132 defines at least two apertures 148, and in particular defines at least two threaded apertures 148, which traverse the thickness between the cylindrical surface 139 and the inner surface 144 (i.e., each aperture 148 extends through the hollow rod 132 from the cylindrical surface 139 to the inner surface 144 and is thus in fluid communication with the cavity 146. As shown in this embodiment, the face 140 contains two threaded apertures 148 spaced apart. It is to be appreciated that there are other configurations possible, and the embodiment shown herein does not limit the disclosure to any particular form. The threaded aperture 148 is configured to receive a set screw 152, which in this embodiment is shown to be a ⅜ inch—16 screw.

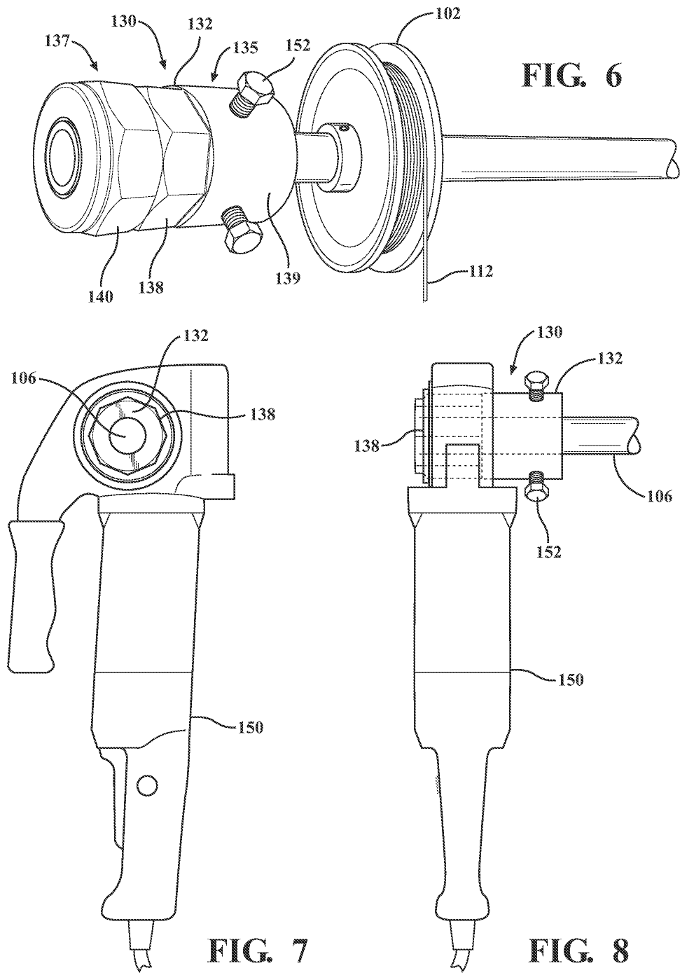

Referring to FIG. 6, the adaptive tool 130 may be mounted upon the spring bar 106 by sliding the cylindrical cavity 146 of the hollow rod 132 onto the spring bar 106 such that the spring bar 106 extends through the cylindrical cavity 146 within the inner surface 144. The adaptive tool 130 can be secured onto the spring bar 106 by turning the set screws 152 contained within the apertures 148 so that they are brought into contact with the outer surface of the spring bar 106, so that rotation of the adaptive tool 130 is reflected by similar rotation in the spring bar 106.

The adaptive tool 130 can be configured for use with a power tool 150. In the shown embodiment of FIG. 7, the power tool 150 is a pipe threader. It is to be appreciated that this embodiment shown herein does not limit the disclosure to any specific tool. The adaptive tool 130 is coupled with the power tool 150 in such a way as to allow the power tool 150 to transfer rotational movement to the adaptive tool 130. As shown in FIGS. 7 and 8, the power tool 150 as the pipe threader which grips the outer surface 138 of the adaptive tool 130 to rotate the adaptive tool 130 when the power tool 150 is actuated. More in particular, the pipe threader grips the outer surface 138 including at least one set of faces 140 of the hollow rod 132 to rotate the adaptive tool 130 when the power tool 150 is actuated.

### III. Winding the Torsion Spring

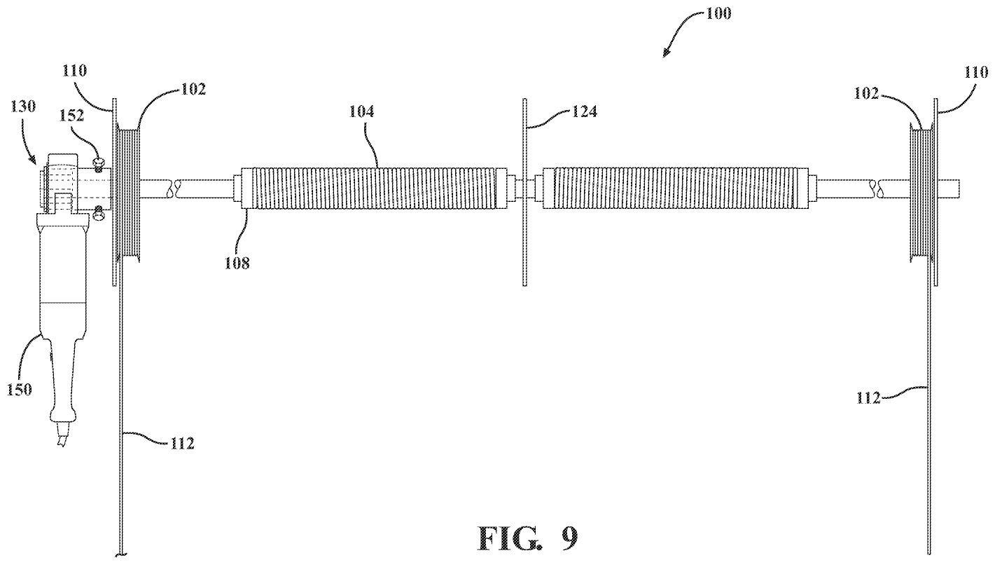

Referring to FIG. 9, to wind the torsion spring 104, a user may mount the adaptive tool 130 upon the spring bar 106 as described above. The rotation of the spring bar 106 may be initially locked using vice grips or any other suitable tool. Then, the cables 112 may be detached from the cable drums 102. The position of the adaptive tool 130 may be secured on the spring bar 106 by one or more set screws 152, and the power tool 150 is then attached or otherwise coupled to the faces 140 of the outer surface 138 of the hollow rod 132, and rotation of the adaptive tool 130 is then initiated by actuation of the power tool 150. In particular, the actuation of power tool 150 rotates the spring bar 106 a predetermined number of rotations or partial rotations in a chosen direction to wind or unwind the torsion spring 104. The number of rotations or partial rotations is based upon the size of the torsion spring 104 and is recommended by the manufacturer of the torsion spring 104. Once the torsion spring 104 is wound to a desired spring tension set by the predetermined and known number of turns, the cables 112 are reattached to the cable drums 102. The power tool 150 is then actuated to rotate the adaptive tool 130 and the spring bar 106 in the reverse direction to eliminate any slack of the cables 112. The adaptive tool 130 is then removed from the spring bar 106. The garage door 114 may then be raised and lowered by actuating the electric door operator, or otherwise wherein the user applies force to raise or lower the garage door 114, with the tensioned torsion spring 104 providing the desired level of assistance in raising or lowering the garage door 114.

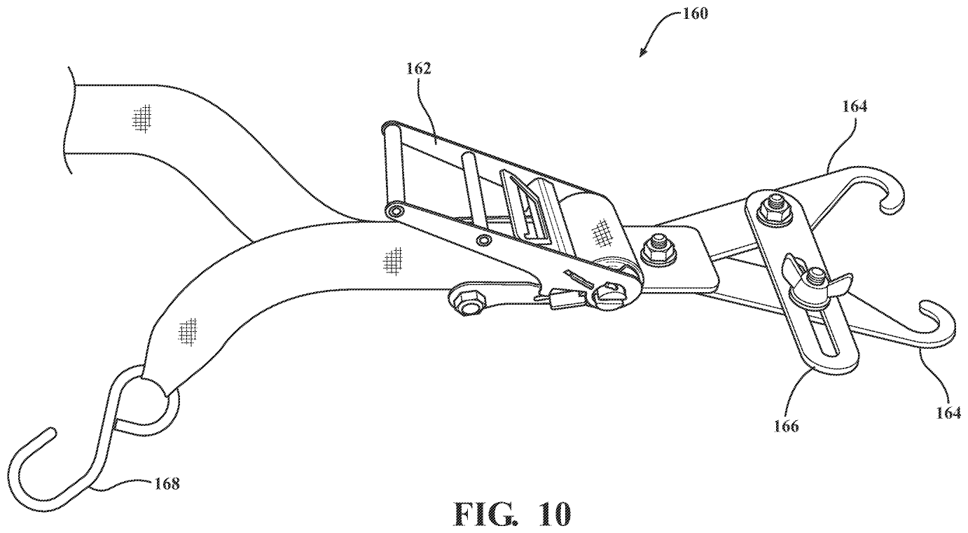

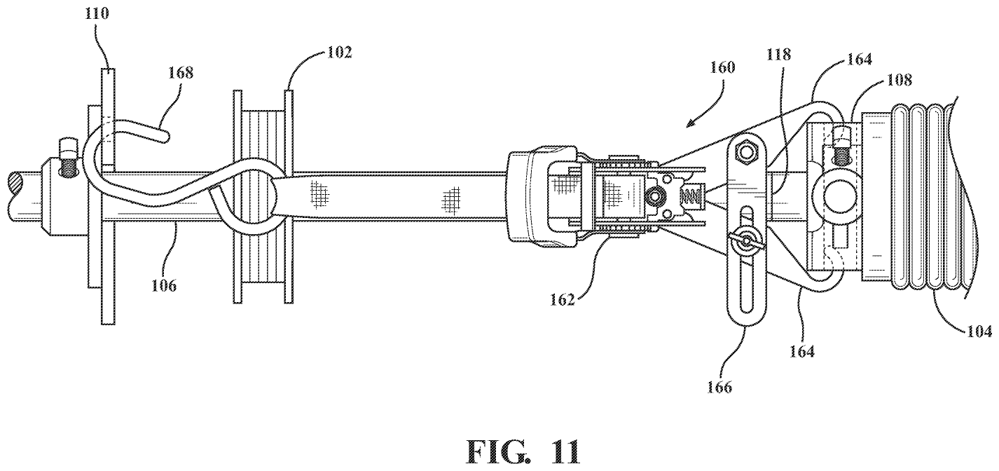

Prior to mounting the adaptive tool 130 onto the spring bar 106, the user may pre-stretch the torsion spring 104. The user may use a pre-stretching device 160 shown in FIG. 10 to displace one end of the torsion spring 104 longitudinally along the spring bar 106. The pre-stretching device 160 may comprise a ratchet strap 162, two hooks 164, and a center bar 166. The pre-stretching device 160 may be attached to the winding cone 108 of the torsion spring 104 as shown in FIG. 11. The center bar 166 may be used to adjust the size of the pre-stretching device 160, allowing for versatility in the size of the torsion spring 104. The pre-stretching device 160 also includes an S-hook 168 on the opposite side of the ratchet strap 162 from the hooks 164. Still referring to FIG. 11, the S-hook 168 may be mounted to the bracket 110. After attaching (or before) the pre-stretching device 160 to the winding cone 108 and the bracket 110, the user may determine the amount of turns the torsion springs 104 should be wound (which is recommended by the manufacturer), measure the combined width of an identical amount of coils of the torsion springs 104 (which is typically ¼″ per turn), add additional length if any partial turns of torsion spring 104 are necessary, and mark a location 118 on the spring bar 106 displaced an equal width from the winding cone 108. The marked location 118 indicates the position that the torsion spring 104 should be stretched to. The pre-stretching device 160 may be used to stretch one end of the torsion spring 104 to the marked location 118 on the spring bar by tightening the ratchet strap and displacing the end of the torsion spring 104 on the spring bar 106. It may be further necessary to partially wind the torsion spring 104 in preparation for winding with the adaptive tool 130. For example, if the size of the torsion spring 104 merits a half wind, the user may manually wind the torsion spring 104 before securing the torsion spring 104 to the spring bar 106 by inserting set screws into the winding cone 108. After inserting set screws into the winding cone 108, the torsion spring 104 is now pre-stretched and properly positioned.

In other embodiments, the user may stretch the torsion spring 104 to the marked location 118 on the spring bar 106 manually or using other means such as a ratchet strap. In the illustrated embodiment shown in FIG. 11, the pre-stretching device 160 is used to stretch the torsion spring 104 to the marked location 118. Additionally, the S-hook 168 of the pre-stretching device 160 may be attached to a plurality of positions on the garage door suspension system 100 and is not limited to the configuration shown herein. Similarly, the hooks 164 of the pre-stretching device 160 may be attached to the winding cone 108 of the torsion spring 104 in configurations not depicted herein.

As known in the industry and appreciated by someone skilled in the art, the torsion springs 104 may bind if winding is completed with no longitudinal displacement of the torsion springs 104. This binding of the torsion springs 104 may be dangerous to an installer during installation or adjustment, may also be dangerous to a subsequent user during normal use to raise or lower the garage door 114, and may also cause premature failure of the garage door suspension system 100. The step of pre-stretching the torsion springs 104 as described allows for a safe adjustment of the torsion springs 104 during installation (i.e., safe balancing of the garage door suspension system 100 prior to use). The degree of displacement of the torsion springs 104 is associated with the manufacturer's recommended number of turns, the size of torsion springs 104, and represents how far the spring will grow if wound by traditional winding methods as is known in the industry.

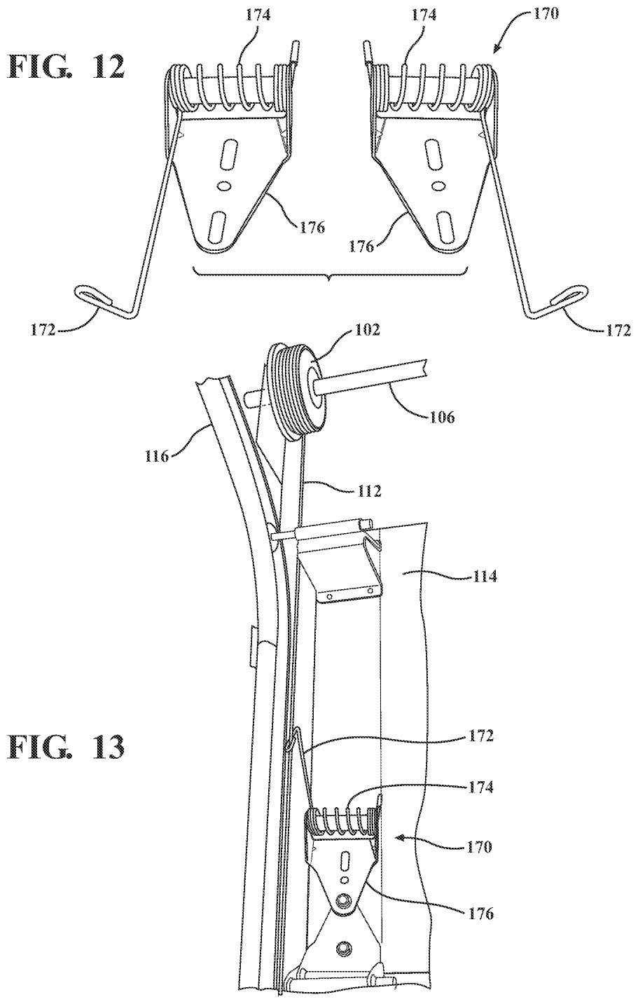

While actuating the power tool 150 and winding the torsion spring 104 as described above, the cables 112 remain detached from the cable drums 102. After winding the torsion spring 104, the cables 112 should be reattached to the cable drums 102. After reattachment, the spring bar 106 should be rotated more to remove any slack in the cables 112. In this process, one or more of a cable lock device 170 may be used to keep the cables 112 on track in the cable drums 102 and properly aligned. Referring to FIG. 12, two embodiments of the cable lock device 170 are shown, one for either side of the garage door 114. The cable lock device 170 includes a cable hook 172, a spring 174, and an attachment plate 176. Now referring to FIG. 13, the cable lock device 170 may be mounted to the garage door 114 with the attachment plate 176 and existing hinges of the garage door 114. The cable hook 172 is placed in contact with the cable 112 and remains held in position as a result of the spring 174. After installing the cable lock device 170, the cable 112 will not slip out of alignment and will remain seated in the cable drum 102, reducing hassle and allowing for smoother operation when winding the torsion spring 104. After the torsion spring 104 is wound and the slack is removed from the cables 112, the cable lock devices 170 may be detached from the cables 112 and uninstalled from the garage door 114.

Conventional garage door suspension systems may include multiple torsion springs 104. As shown in FIGS. 1 and 9, the garage door suspension system in the illustrated embodiment contains two torsion springs 104. In some cases, the torsion springs 104 can be simultaneously wound by pre-stretching both torsion springs 104 and detaching both cables 112. Then, the spring bar 106 may be rotated in the same way by the adaptive tool 130, and both springs would be wound concurrently. This is a significant advantage over existing methods, which generally require torsion springs 104 to be wound independently, therefore increasing the risk of injury, physical labor, and time required.

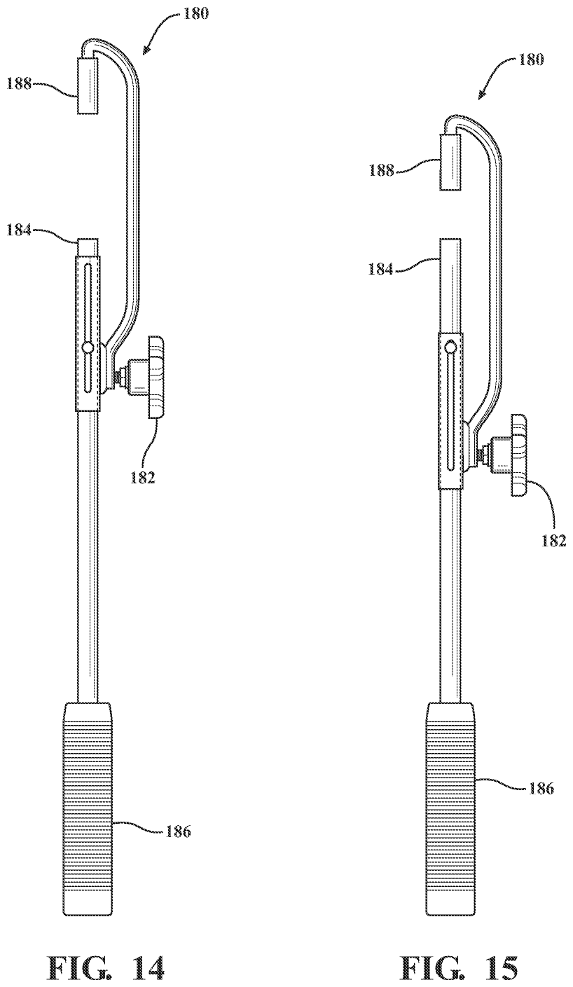

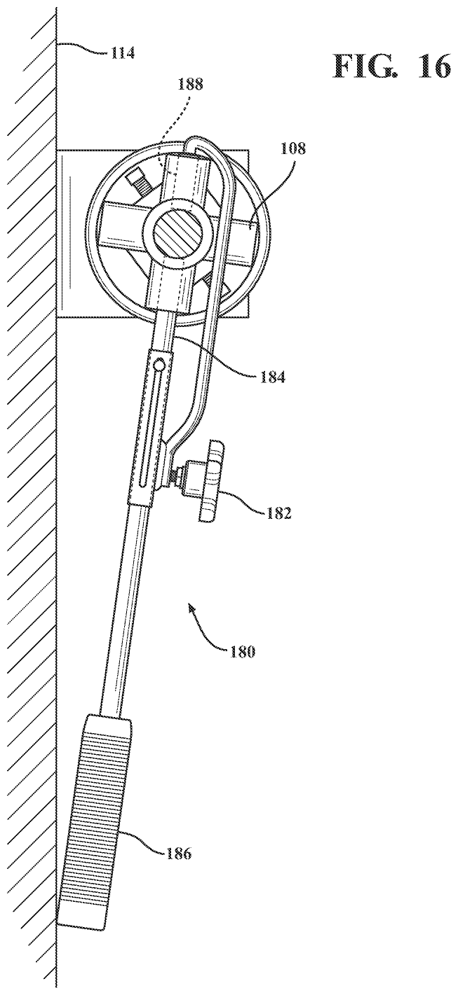

In other embodiments, there may be cases with particularly large torsion springs 104 that require more torque to be wound to the desired amount of torsion. Because of the increased load, a spring locking tool 180 may be used to wind the torsion springs 104 independently. Referring to FIG. 14, an open configuration of the spring locking tool 180 is shown. FIG. 15 shows a closed configuration of the spring locking tool 180. The spring locking tool 180 includes an adjustment screw 182, a locking bar 184, a handle 186, and a rod 188. The adjustment screw 182 may be manually rotated to enable the locking bar 184 to slide into an open position (as shown in FIG. 13) or to slide into a closed position (as shown in FIG. 15). The adjustment screw 182 may then be tightened to secure the position of the locking bar 184. Now referring to FIG. 16, the spring locking tool 180 may be used to hold one torsion spring 104 in position after being wound to stop the torsion spring 104 from unwinding while the user winds another torsion spring 104 independently. The handle 186 may be used to wedge the spring locking tool 180 against the garage door 114 to secure the position of the torsion spring 104. The rod 188 may be inserted into one aperture of the winding cone 108, and the locking bar 184 may be inserted into another aperture of the winding cone 108 on the opposite side of the rod 188. If necessary, the adjustment screw 182 may be used to adapt the spring locking tool 180 to a larger configuration suitable for a larger torsion spring 104. In the illustrated embodiment of FIG. 16, the spring locking tool 180 holds the torsion spring 104 in place after winding, and maintains the torsion stored in the torsion spring 104 while the user winds another torsion spring 104 in the garage door suspension system 100. The spring locking tool 180 is a safe way to hold a wound torsion spring and stabilizes the spring to minimize any risk of the torsion spring 104 unwinding, which would be likely to cause injury.

As described above, the balance of the garage door suspension system 100 is desirable prior to the use of the garage door 114. Although the degree of winding of torsion springs 104 is predetermined by its size, sometimes adjustments are necessary for specific circumstances. In these circumstances, the adaptive tool 130 can be used to perform an adjustment. Prior to removing the adaptive tool 130 from the spring bar 106 but after the cables 112 have been attached to the cable drums 102, the balance of garage door 114 can be assessed by providing an external force to open the garage door 114 (either by actuating the electric door operator to raise the garage door 114 or wherein the user manually lifts the garage door 114). If the garage door 114 is too difficult to open, then the adaptive tool 130 can be actuated by power tool 150 in order to increase the winding of the torsion springs 104. If the garage door 114 is excessively easy to open, the adaptive tool 130 can be used to decrease the winding of the torsion springs 104. These adjustments are desirable to enhance the safety and ease of operation of the garage door suspension system 100.

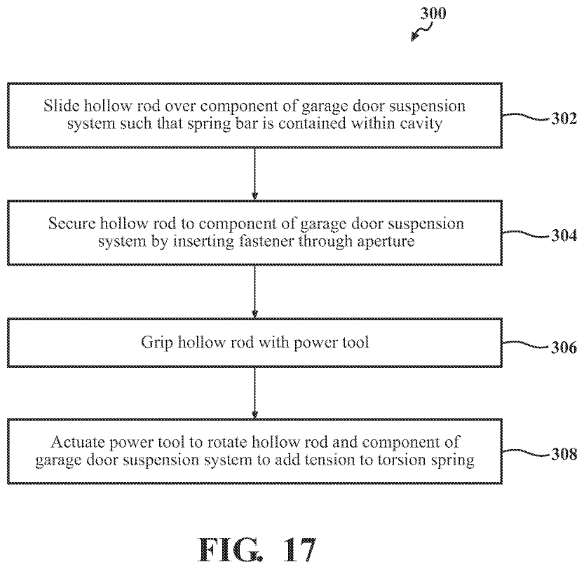

A method 300 of winding the torsion spring 104 of the garage door suspension system 100 with the adaptive tool 130 is illustrated in FIG. 17. At step 302, a user may slide the hollow rod 132 over the spring bar 106 such that the spring bar 106 is contained within the cavity 146 as shown in FIG. 6 and described above in Section II. At step 304, the user may secure the hollow rod 132 to the spring bar 106 by inserting a fastener through the aperture 148, as shown in FIG. 6 and described above in Section II. At step 306, the user may grip the hollow rod 132 with the power tool 150, as shown in FIGS. 7 and 8 and described above in Section II. At step 308, the user may actuate the power tool 150 to rotate the hollow rod 132 and the spring bar 106 to add tension to the torsion spring 104, as described above in Section III.

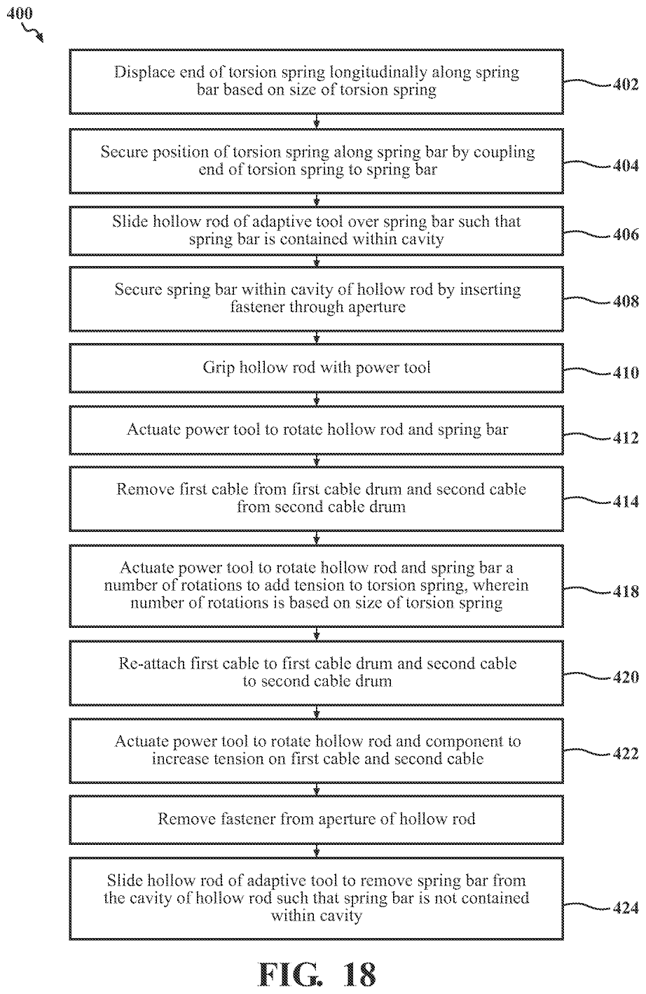

A method 400 of balancing the garage door suspension system 100 with the adaptive tool 130 is illustrated in FIG. 18. At step 402, the user may displace the end of the torsion spring 104 longitudinally along the spring bar 106 based on the size of the torsion spring 104, as shown in FIG. 11 and described in Section III. At step 404, the user may secure the position of the torsion spring 104 along the spring bar 106 by coupling the torsion spring 104 to the spring bar 106, as described above in Section III. At step 406, the user may slide the hollow rod 132 over the spring bar 106 such that the spring bar 106 is contained within the cavity 146, as shown in FIG. 6. At step 408, the user may secure the hollow rod 132 to the spring bar 106 by inserting a fastener (such as the set screw 152) through the aperture 148, as shown in FIG. 6. At step 410, the user may grip the hollow rod 132 with the power tool 150, as shown in FIG. 7. At step 412, the user may actuate the power tool 150 to rotate the hollow rod 132 and the spring bar 106, as described above in Section III. At step 414, the user may remove the cables 112 from the cable drums 102, as described above in Section III. At step 416, the user may actuate the power tool 150 to rotate the hollow rod 132 and the spring bar 106 a number of rotations based on the size of the torsion spring 104 to add tension to the torsion spring 104, as described above in Section III. At step 418, the user may re-attach the cables 112 to the cable drums 102. At step 420, the user may actuate the power tool 150 to rotate the hollow rod 132 and the spring bar 106 to increase tension on the cables 112, as described in Section III. At step 422, the user may remove the fastener 152 from the aperture 148 of the hollow rod 132. At step 424, the user may slide the hollow rod 132 to remove the spring bar 106 from the cavity 146 of the hollow rod 132 such that the spring bar 106 is no longer contained within the cavity 146.

Any of the above methods may be executed independently, or concurrently with the other disclosed methods, and any of the presented steps may be executed in any combination or order not disclosed herein.

As known in the industry and appreciated by someone skilled in the art, existing torsion spring winding methods can only be applied to torsion spring 104 at a time. The adaptive tool 130 allows the spring bar 106 itself to rotate, which results in each and every torsion spring 104 mounted in the garage door suspension system 100 to be wound simultaneously. This greatly reduces the time of the procedure and the risk to the user.

Several configurations have been discussed in the foregoing description. However, the configurations discussed herein are not intended to be exhaustive or limit the disclosure to any particular form. The terminology which has been used is intended to be in the nature of words of description rather than of limitation. Many modifications and variations are possible in light of the above teachings and the disclosure may be practiced otherwise than as specifically described.

1. An adaptive tool for winding a torsion spring of a garage door suspension system, comprising:
a hollow rod configured to interact with a power tool, wherein the hollow rod defines:
a cavity configured to receive a component of the garage door suspension system; and
an aperture configured to receive a fastener for coupling the hollow rod to the component of the garage door suspension system,
wherein the hollow rod comprises an exterior surface, the exterior surface having a plurality of faces configured to be gripped by the power tool.

2. The adaptive tool of claim 1, wherein the cavity is further defined as a cylindrical cavity, and wherein the hollow rod comprises an internal surface defining the cylindrical cavity.

3. The adaptive tool of claim 2, wherein the hollow rod comprises a first section and a second section.

4. The adaptive tool of claim 3, wherein a shape of the first section is different than a shape of the second section.

5. The adaptive tool of claim 4, wherein the second section includes the aperture.

6. The adaptive tool of claim 5, wherein the aperture includes a threaded geometry.

7. The adaptive tool of claim 1, wherein the fastener is configured to contact the component to couple the hollow rod to the component.

8. The adaptive tool of claim 5, wherein the aperture is further defined as a first aperture and further comprising a second aperture wherein the second aperture is spaced from the first aperture.

9. The adaptive tool of claim 8, wherein the second section includes the second aperture.

10. A method of winding a torsion spring of a garage door suspension system with an adaptive tool having a hollow rod, the hollow rod defining an aperture configured to receive a fastener and a cavity configured to receive a component of the garage door suspension system including the torsion spring, the method comprising steps of:
sliding the hollow rod over the component of the garage door suspension system such that the component is contained within the cavity;
securing the hollow rod to the component of the garage door suspension system by inserting the fastener through the aperture;
gripping the hollow rod with a power tool; and
actuating the power tool to rotate the hollow rod and the component of the garage door suspension system to add tension to the torsion spring.

11. The method of claim 10, wherein the step of actuating the power tool to rotate the hollow rod and the component of the garage door suspension system comprises a step of actuating the power tool to rotate the hollow rod and the component a number of rotations, wherein the number of rotations is based on a size of the torsion spring.

12. The method of claim 10, wherein the step of securing the hollow rod to the component of the garage door suspension system comprises a step of threading a threaded fastener through the aperture.

13. The method of claim 10, further comprising a step of removing the hollow rod from the component of the garage door suspension system.

14. The method of claim 13, wherein the step of removing the hollow rod from the component of the garage door suspension system comprises securing a degree of rotation of the torsion spring with a locking device.

15. The method of claim 14, wherein the torsion spring is further defined as a first torsion spring and further comprising a step of actuating the power tool to rotate the hollow rod and the component to wind a second torsion spring.

16. The method of claim 15, wherein the step of actuating the power tool to rotate the hollow rod and the component to wind the second torsion spring comprises:
displacing an end of the second torsion spring longitudinally along the component based on a size of the second torsion spring;
securing a position of the second torsion spring along the component by coupling the end of the second torsion spring to the component of the garage door suspension system; and
actuating the power tool to rotate the hollow rod and the component a number of rotations, wherein the number of rotations is based on the size of the second torsion spring.

17. A method of balancing a garage door suspension system including a first cable drum, a second cable drum, a first cable, and a second cable with an adaptive tool having a hollow rod, the hollow rod defining an aperture configured to receive a fastener and a cavity configured to receive a spring bar including a torsion spring, the method comprising steps of:
displacing an end of the torsion spring longitudinally along the spring bar based on a size of the torsion spring;
securing a position of the torsion spring along the spring bar by coupling the end of the torsion spring to the spring bar;
sliding the hollow rod of the adaptive tool over the spring bar such that the spring bar is contained within the cavity;
securing the spring bar within the cavity of the hollow rod by inserting the fastener through the aperture;
gripping the hollow rod with a power tool;
actuating the power tool to rotate the hollow rod and the spring bar;
removing the first cable from the first cable drum and the second cable from the second cable drum;
actuating the power tool to rotate the hollow rod and the spring bar a number of rotations to add tension to the torsion spring, wherein the number of rotations is based on the size of the torsion spring;
re-attaching the first cable to the first cable drum and the second cable to the second cable drum;
actuating the power tool to rotate the hollow rod and the spring bar to increase tension on the first cable and the second cable;
removing the fastener from the aperture of the hollow rod; and
sliding the hollow rod of the adaptive tool to remove the spring bar from the cavity of the hollow rod such that the spring bar is not contained within the cavity.

18. The method of claim 17, wherein the end of the torsion spring is further defined as a first end and balancing the garage door suspension system further comprises installing components of the garage door suspension system, comprising steps of:
mounting the spring bar of the garage door suspension system including the torsion spring, the first cable drum, and the second cable drum to a wall;
attaching the first cable to the first cable drum and locking the rotation of the spring bar;
attaching the second cable to the second cable drum and tightening the first cable and the second cable;
securing a second end of the torsion spring to a center mounting plate.

19. The method of claim 17, further comprising steps of:
securing the first cable with a first cable lock device and the second cable with a second cable lock device after actuating the power tool to remove tension from the first cable and the second cable; and
removing the first cable lock device and the second cable lock device after actuating the power tool to add tension to the torsion spring.

20. The method of claim 19, wherein the torsion spring is further defined as a first torsion spring and further comprising a step of actuating the power tool to rotate the hollow rod and the component to wind a second torsion spring comprising:
locking the rotation of the first torsion spring with a spring locking device;
displacing an end of the second torsion spring longitudinally along the component based on a size of the second torsion spring;
securing a position of the second torsion spring along the component by coupling the end of the second torsion spring to the component of the garage door suspension system; and
actuating the power tool to rotate the hollow rod and the component a number of rotations to add tension to the torsion spring, wherein the number of rotations is based on the size of the second torsion spring.
